(19) United States
(12) Patent Application Publication
(10) Pub. No.: US 2012/0067828 A1
(43) Pub. Date: Mar. 22, 2012

(54) PHOTOCATALYST AND METHOD FOR PRODUCTION

(75) Inventors: Fang Han, South Australia (AU); Venkata Subba Rao Kambala, South Australia (AU); Ravendra Naidu, South Australia (AU)

(73) Assignee: CRC Care Pty., Ltd.

(21) Appl. No.: 13/201,839

(22) PCT Filed: Feb. 16, 2010
(86) PCT No.: PCT/AU10/00159

§ 371 Date: Oct. 24, 2011

(30) Foreign Application Priority Data
Feb. 16, 2009 (AU) 2009900643

(51) Int. Cl. C02F 1/72; C02F 1/30; B01J 21/06; C02F 1/32; C02F 103/04; C02F 101/30; C02F 101/38

(52) U.S. Cl. 210/748.09; 502/350; 210/763; 210/748.14

(57) ABSTRACT

The present invention relates generally to methods for producing modified titanium dioxide based photocatalysts via a sol-gel process. The present invention also relates to photocatalysts produced according to the methods of the invention and uses of the photocatalysts for the degradation of contaminants in samples.

### CROSS-REFERENCE TO RELATED APPLICATIONS

This application is the U.S. National Phase application under 35 U.S.C. §371 of International Application No. PCT/AU2010/000159, filed on 16 Feb. 2010, which in turn claims the benefit of Australian provisional patent application 2009900643, filed on 16 Feb. 2009, the entire contents of each of which are hereby expressly incorporated herein by reference.

### BACKGROUND

The present invention relates generally to titanium dioxide-based photocatalysts, as well as methods for their production and/or use.

The widespread disposal of industrial wastewater containing organic dyes onto land and water bodies has led to serious contamination in many countries worldwide. About 1-20% of the total global production of dyes is lost during the dyeing process and is released into the environment as textile effluent.

Weathering of organic dyes through oxidation, hydrolysis, or other chemical reactions occurring in wastewaters can produce toxic metabolites. Such products impact adversely on the environment, especially animal, human and environmental health. Given the adverse impact of organic residues present in wastewater, it would be desirable to treat wastewater to reduce environmental contamination.

The reuse and recycling of wastewater would also be desirable to conserve fresh water supplies. Available fresh water amounts to less than one half of one percent of all the water on Earth. Global consumption of water is doubling every 20 years, more than twice the rate of human population growth. Thus, to help ensure fresh water supplies it would be desirable to reclaim at least some polluted water, such as wastewaters.

Because of the recalcitrant nature of synthetic dyes and the generally high salinity of dye wastewater, conventional biological treatment processes may be ineffective in removing the color from at least some dye industry wastewater. Under anaerobic conditions azo dyes are also readily reduced to potentially hazardous aromatic amines. Adsorption and coagulation practices may be applied to treat dyes in wastewater, but this may lead to secondary pollution.

Advanced oxidation process (AOPs) can oxidize a broad range of organic dyes quickly and non-selectively. These processes are characterized by the production of hydroxyl radicals (.OH) and superoxide anions (O₂^{.-}). These agents can be generated with a semiconductor acting as catalyst that absorbs radiation when in contact with water and oxygen. Amongst various oxide semiconductor photocatalysts, titanium dioxide is the most widely used due to its strong oxidizing power, non-toxicity and long-term photostability.

However, the photocatalytic efficiency of TiO₂ to degrade dyes decreases substantially due to the high recombination ratio of photo-induced electrons (e⁻) and holes (h⁺) produced under the irradiation of ultraviolet (UV) light (λ<380 nm).

Moreover, there are some disadvantages with the use of powder forms of TiO₂ like stirring during the reaction and separation of catalyst from the treated water after each run. Separation methods such as sedimentation, centrifugation and filtration become increasingly inefficient as the particle size diminishes, as it is easy for smaller particles to stay suspended in the water, penetrate through filtration materials, and clog filter membranes. To address the catalyst retrieval problem, TiO₂ has been immobilized on solid supports as bound particles or thin solid films. However, TiO₂ exhibits photocatalytic activity on its surface under irradiation with light and contact with the organic pollutant. As a result, a decrease in the overall photocatalytic performance of thin films relative to a slurry is expected, due to the lower surface area of the former.

Thus, development of TiO₂ photocatalysts with high degradation efficiency and easy separation from treated water is also desirable.

The optimum irradiation wavelength for photocatalytic activity of unmodified TiO₂ is 300 nm (which corresponds to the band-gap energy of 3.02 ev). This wavelength lies in the near-ultraviolet region of the electromagnetic spectrum. Accordingly, the use of unmodified TiO₂ as a photocatalyst is generally limited to applications where a UV light source is available.

However, it would be desirable to develop TiO₂ photocatalysts which can utilize a broader spectrum of solar radiation, including visible light.

Reference to any prior art in this specification is not, and should not be taken as, an acknowledgment or any form of suggestion that this prior art forms part of the common general knowledge in any country.

### SUMMARY

The present invention relates generally to methods for producing modified titanium dioxide based photocatalysts via a sol-gel process. The present invention also relates to photocatalysts produced according to the methods of the invention and uses of the photocatalysts.

In a first aspect, the present invention provides a method for producing a photocatalyst, the method comprising:
providing a reaction mixture containing:
   a titanium alkoxide;
   nitric acid;
   water; and
   a metal nitrate;
maintaining the reaction mixture for a time and under conditions to allow the formation of a gel; drying and/or calcining the gel.

The reaction of the titanium alkoxide, nitric acid and water in the reaction mixture leads to the production of a titanium dioxide gel via an acid-catalysed sol-gel process. The provision of the metal nitrate in the reaction mixture leads to the incorporation of metal atoms in the titanium dioxide lattice which, among other things, leads to modulation of the band gap energy of the titanium dioxide and thus modulation of the wavelengths of light under which the modified titanium will exhibit photocatalytic activity. After production of the gel, the gel is then dried and/or calcined to produce a titanium dioxide matrix of the desired morphology.

As set out above, the method of the present invention contemplates the use of both nitric acid and a metal nitrate in the reaction mixture. These were chosen because the nitrate anion (NO₃)⁻ was found to not adversely interfere with the synthesis process and to also allow the production of photocatalysts having desirable properties.

In a second aspect, the present invention provides a photocatalyst produced according to the method of the first aspect of the invention.

In some embodiments, the photocatalyst has increased photocatalytic activity under visible light irradiation relative to unmodified titanium dioxide under visible light irradiation. In some embodiments, the photocatalyst has increased photocatalytic activity under solar radiation relative to unmodified titanium dioxide under solar radiation.

In the third aspect, the present invention provides a method for degrading a contaminant in a sample containing the contaminant, the method comprising contacting the sample with a photocatalyst according to the second aspect of the invention under conditions suitable for degradation of the contaminant by the photocatalyst.

The contaminant contemplated in the third aspect of the invention includes any contaminant which may be amenable to photocatalyst-mediated degradation.

In some embodiments, however, the photocatalysts of the present invention have particular application for the degradation of organic dyes. In some embodiments, the contaminant or organic dye may be an azo compound, including azo dye compounds.

In some embodiments, the conditions suitable for degradation of the contaminant by the photocatalyst, according to the third aspect of the invention, comprise visible light irradiation. In some embodiments, the conditions suitable for degradation of the contaminant by the photocatalyst comprise solar radiation.

### BRIEF DESCRIPTION OF THE DRAWINGS

FIG. 1 shows Acid orange 7 (AO7) degradation under UV light irradiation, AO7 initial concentration 50 mg 1⁻¹, catalyst dosage 100 mg 1⁻¹, blank: UV light only.

FIG. 2 shows the UV-Vis absorption spectra of synthesized and commercial photocatalysts.

FIG. 3 shows Acid orange 7 (AO7) degradation under visible light irradiation, AO7 initial concentration 25 mg 1⁻¹, catalyst dosage 500 mg 1⁻¹, blank: visible light only.

FIG. 4 shows photocatalytic degradation of artificial textile wastewater (mixture of Drimarene Navy KBNN GRAN, Drimarene Yellow K-2R, Maxilon Red GRL 200%, 15 mg 1⁻¹ each) under visible light irradiation, catalyst dosage 500 mg 1⁻¹, blank: visible light only.

FIG. 5 shows real textile waste water purification under visible light irradiation. Panel A shows wastewater sampled from Melba Industries located in Geelong, Victoria. Panel B shows decolourisation of the wastewater under visible light irradiation in the presence of the synthesized photocatalyst added at 500 mg 1⁻¹.

FIG. 6 shows the repeated use of synthesized photocatalyst for cycling runs in AO7 photodegradation under UV irradiation: catalyst dosage 100 mg 1⁻¹, AO7 initial concentration 50 mg 1⁻¹ per run; and visible light irradiation: catalyst dosage 500 mg 1⁻¹, AO7 initial concentration 25 mg 1⁻¹ per run.

FIG. 7 is a graphical representation showing the photocatalytic degradation of AO7 solution (50 mg 1⁻¹) under solar radiation. Catalyst dosage 500 mg 1⁻¹.

FIG. 8 is a pictorial representation of the data shown in FIG. 7 illustrating the AO7 degradation process using lab synthesized photocatalyst. Panels A-G show the colour of the reaction mixture at 0, 1, 2, 3, 4, 5 and 6 hours, respectively. Panel H shows the reaction mixture at 6 hours after sedimentation of the photocatalyst.

FIG. 9 is a pictorial representation illustrating the decolorization process of simulated textile wastewater using the synthesized photocatalyst under solar-light at time intervals of 0, 2, 4, 6, 8, and 10 h (shown in panels A-F, respectively). Panel G shows the reaction mixture at 10 h after partial sedimentation of the photocatalyst.

FIG. 10 is a graphical representation showing solar-light induced mineralization of simulated textile wastewater using the synthesised photocatalyst.

FIG. 11 is a pictorial representation illustrating the degradation process of the textile wastewater using the synthesised photocatalyst under solar light at time intervals of 0, 1, 2, 4, 6, 8, and 10 h (shown in panels A-G, respectively). Panel H shows the reaction mixture at 10 h after sedimentation of the photocatalyst.

FIG. 12 is a graphical representation showing mineralization of 500 ml of textile wastewater with the application of the synthesised photocatalyst (2 wt. % Fe³⁺—TiO₂) and P25 TiO₂ (500 mg L⁻¹) under solar light. Blank: solar light only.

### DETAILED DESCRIPTION

It is to be understood that the following description is for the purpose of describing particular embodiments only and is not intended to be limiting with respect to the above summary. Where used herein, the singular forms “a”, “an” and “the” include plural aspects unless the context already dictates otherwise. Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

In a first aspect, the present invention provides a method for producing a photocatalyst, the method comprising:
providing a reaction mixture containing:
   a titanium alkoxide;
   nitric acid;
   water; and
   a metal nitrate;
maintaining the reaction mixture for a time and under conditions to allow the formation of a gel;
drying and/or calcining the gel.

The reaction of the titanium alkoxide, nitric acid and water in the reaction mixture leads to the production of a titanium dioxide gel via an acid-catalysed sol-gel process. The provision of the metal nitrate in the reaction mixture leads to the incorporation of metal atoms in the titanium dioxide lattice which, among other things, leads to modulation of the band gap energy of the titanium dioxide and thus modulation of the wavelengths of light under which the modified titanium will exhibit photocatalytic activity. After production of the gel, the gel is then dried and/or calcined to produce a titanium dioxide matrix of the desired morphology.

In some embodiments, the titanium alkoxide is provided as a solution in an alcohol solvent. The alcohol solvent may be any suitable alcohol solvent. In some embodiments the alcohol may be, but is not limited to, ethanol, methanol, isopropanol, and butanol.

As set out above, the present invention contemplates the addition of nitric acid to the reaction mixture. In some embodiments, the nitric acid is added to the titanium alkoxide solution before addition of the water and metal nitrate to the reaction mixture. In some embodiments, nitric acid is added to the titanium alkoxide solution such that the pH of the solution of titanium alkoxide and nitric acid is in the range of about 1.8 to about 2.1. In some embodiments, nitric acid is added to the titanium alkoxide mixture such that the pH of the solution of titanium alkoxide and nitric acid is about 2.

As set out above, the present invention contemplates the addition of nitric acid to the reaction mixture. In some embodiments, the nitric acid is added to the titanium alkoxide solution before addition of the water and metal nitrate to the reaction mixture. In some embodiments, nitric acid is added to the titanium alkoxide solution such that the pH of the solution of titanium alkoxide and nitric acid is in the range of about 1.8 to about 2.1. In some embodiments, nitric acid is added to the titanium alkoxide mixture such that the pH of the solution of titanium alkoxide and nitric acid is about 2.

Reference herein to a pH “about” a particular value may encompass pH values of ±50%, ±40%, ±30%, ±20%, ±15%, ±10%, ±5%, ±4%, ±3%, ±2% or ±1% of the defined pH value.

The present invention contemplates the provision of the reagents in the reaction mixture at any suitable amounts for the production of a titanium dioxide gel having desired properties.

However, in some embodiments, the molar ratio of alcohol:titanium alkoxide: H₂O in the reaction mixture is about 25:1:3.5.

However, in some embodiments, the molar ratio of alcohol:titanium alkoxide: H₂O in the reaction mixture is about 25:1:3.5.

The molar ratio defined above has been demonstrated to lead to the production of photocatalysts having particularly desirable properties such as fine particle size, large surface area, even distribution of metal in the titania matrix and superior visible light photoactivity.

As set out above, the present invention contemplates a “titanium alkoxide” in the reaction mixture. The present invention contemplates the use of any titanium alkoxide which can react with water to produce a titanium oxide based gel via a sol-gel process. Suitable titanium alkoxides include, for example, titanium butoxide and titanium isopropoxide.

In some embodiments, the titanium alkoxide is titanium butoxide.

As set out above, due to the limited solubility in water of titanium alkoxides, such as titanium butoxide and titanium isopropoxide, the titanium alkoxide may be supplied in the reaction mixture as a solution in an alcohol solvent such as ethanol.

As set out above, the present invention contemplates the use of a metal nitrate in the reaction mixture as a means of providing metal ions for incorporation into the photocatalysts of the present invention.

Any suitable metal nitrate may be used in the reaction mixture. However, in some embodiments, suitable metal nitrates include ferric nitrate, silver nitrate, platinum nitrate and copper nitrate. In some specific embodiments, the metal nitrate is ferric nitrate.

The metal nitrate may be added at any suitable concentration to provide a photocatalyst with the desired properties. In some embodiments wherein the metal nitrate is ferric nitrate, a concentration of 0.5-5 wt. %, 1-3 wt. %, or about 2 wt. % ferric ions in the final titanium dioxide matrix was identified as being suitable for the production of photocatalysts having desirable properties.

Nitrate salts of metals were used as a metal source, as the nitrate anion (NO₃)⁻ did not adversely interfere with the synthesis process in obtaining the final and desired photocatalyst with high efficiency. The compatibility of the nitrate anion with the reaction process described herein was also a reason why nitric acid is used as the acid in the reaction.

Nitrite salts were not used due to the carcinogenic nature of nitrite group (NO₂)⁻.

As set out above the present invention contemplates drying and/or calcining the gel formed in the method.

Drying the gel may be performed by a range of methods. A particularly suitable method is to dry the gel at a high temperature and/or under a vacuum. In some embodiments, drying the gel comprises drying at about 60° C.-70° C. under vacuum for about 3 hours

The present invention also contemplates calcining of the gel in addition to, or instead of, drying the gel. Calcining is a thermal process in which a material is heated to a temperature below its melting point to effect a thermal decomposition, a phase transition (including the transformation of titania from an amorphous to crystalline) and/or removal of a volatile fraction.

In some embodiments, calcining the gel comprises calcining at about 450° C. for about 3 hours.

Reference herein to a temperature of “about” a particular temperature may encompass temperatures ±50%, ±40%, ±30%, ±20%±15%, ±10%, ±5%, ±4%, ±3%, ±2% or ±1% of the defined temperature. Similarly, reference herein to a time of “about” a particular duration may encompass durations of ±50%, ±40%, ±30%, ±20%, ±15%, ±10%, ±5%, ±4%, ±3%, ±2% or ±1% of the defined duration.

In a second aspect, the present invention provides a photocatalyst produced according to the method of the first aspect of the invention.

In some embodiments, the photocatalyst of the present invention may be used in reactions that normally use unmodified titanium dioxide as a photocatalyst. Such reactions are known in the art.

In addition, the photocatalyst of the present invention may also be used in reactions for which unmodified titanium dioxide is not optimal. For example, the photocatalyst of the present invention may be an effective photocatalyst under conditions not suited to the photocatalytic activity of unmodified titanium dioxide, such as photocatalysis under primarily visible light irradiation and/or solar radiation.

In some embodiments, the photocatalyst has increased photocatalytic activity under visible light irradiation relative to unmodified titanium dioxide under visible light irradiation.

“Visible light” as referred to herein encompasses light having a wavelength from about 380 nm to about 780 nm.

“Unmodified titanium dioxide” should be understood as titanium dioxide which been produced by a method other than that of the present invention. In some embodiments, unmodified titanium dioxide should be understood as titanium dioxide which is substantially devoid of any atoms other than titanium and oxygen, including substantially pure titanium dioxide.

In some embodiments, the photocatalyst has increased photocatalytic activity under solar radiation relative to unmodified titanium dioxide under solar radiation.

“Solar radiation” encompasses the radiation of the sun that reaches the surface of the Earth, and may also be referred to as insulation. Solar radiation is spread over a wide frequency range and contains electromagnetic wavelengths as short as 200 nm (Ultraviolet) with maximum energy centered at around 400 nm (blue light). Solar radiation also includes some longer wave infrared radiation, however large bands of this radiation are absorbed by gasses and particles within the upper atmosphere. Ultraviolet (UV) radiation makes up a small part of the total energy content of solar radiation, roughly 8%-9%. The visible range, with a wavelength of about 350 nm to about 780 nm, represents about 46%-47% of the total energy received from the sun. The final ˜45% of the sun's total energy is in the near-infrared range of above 780 nm to about 5 μm. As solar radiation passes through the Earth's atmosphere, some of it is absorbed and scattered by air molecules, small airborne particles, water vapour, aerosols and clouds. The solar radiation that passes directly through to the Earth's surface is called Direct Solar Radiation. The radiation that has been scattered out of the direct beam is called Diffuse Solar Radiation. Solar radiation, as referred to herein, should be understood to encompass both direct and diffuse solar radiation.

In a third aspect, the present invention provides a method for degrading a contaminant in a sample containing the contaminant, the method comprising contacting the sample with a photocatalyst according to the second aspect of the invention under conditions suitable for degradation of the contaminant by the photocatalyst.

The contaminant contemplated in the third aspect of the invention includes any contaminant which may be amenable to photocatalyst-mediated degradation.

In some embodiments, however, the photocatalysts of the present invention have particular application for the degradation of organic dyes.

Organic dyes include compounds which include carbon atoms and absorb radiation in the near ultraviolet, visible and/or near infrared parts of the spectrum. Examples of organic dyes include: azo dyes such as Acid orange dyes, Acid red dyes, Acid yellow dyes, Direct violet dyes, Direct yellow dyes, Sudan dyes and Methyl dyes and the like; Drimarene dyes or reactive dyes such as Drimarene CL dyes, Drimarene K dyes, Drimarene P dyes, Drimarene R dyes, Drimarene S dyes and Drimarene X/XN dyes; Maxilon dyes or basic dyes such as Maxilon Orange, Maxilon red and the like; Teratop dyes or disperse dyes such as Teratop yellow, Teratop pink, Teratop blue and the like; Nylosan dyes or acid dyes such as Nylosan red, Nylosan blue and the like.

In some embodiments, the contaminant or organic dye may be an azo compound, including an azo dye (described later). Azo compounds include compounds comprising the general structure of:

R¹—N═N—R² (II)

wherein R¹ and R² are independently selected from either aryl or alkyl.

“Aryl” as a group or part of a group denotes (i) an optionally substituted monocyclic, or fused polycyclic, aromatic carbocycle (ring structure having ring atoms that are all carbon) preferably having from 5 to 18 atoms per ring. Examples of aryl groups include optionally substituted phenyl, optionally substituted naphthyl, and the like; (ii) an optionally substituted partially saturated bicyclic aromatic carbocyclic moiety in which a phenyl and a C₅₋₇ cycloalkyl or C₅₋₇ cycloalkenyl group are fused together to form a cyclic structure, such as tetrahydronaphthyl, indenyl or indanyl.

The term “optionally substituted” as used throughout the specification denotes that the group may or may not be further substituted or fused (so as to form a condensed polycyclic system), with one or more non-hydrogen substituent groups. In certain embodiments the substituent groups are one or more groups independently selected from the group consisting of halogen, ═O, ═S, —CN, —NO₂, —CF₃, —OCF₃, alkyl, alkenyl, alkynyl, haloalkyl, haloalkenyl, haloalkynyl, heteroalkyl, cycloalkyl, cycloalkenyl, heterocycloalkyl, heterocycloalkenyl, aryl, heteroaryl, cycloalkylalkyl, heterocycloalkylalkyl, heteroarylalkyl, arylalkyl, cycloalkylalkenyl, heterocycloalkylalkenyl, arylalkenyl, heteroarylalkenyl, cycloalkylheteroalkyl, heterocycloalkylheteroalkyl, arylheteroalkyl, heteroarylheteroalkyl, hydroxy, hydroxyalkyl, alkyloxy, alkyloxyalkyl, alkyloxycycloalkyl, alkyloxyheterocycloalkyl, alkyloxyaryl, alkyloxyheteroaryl, alkyloxycarbonyl, alkylaminocarbonyl, alkenyloxy, alkynyloxy, cycloalkyloxy, cycloalkenyloxy, heterocycloalkyloxy, heterocycloalkenyloxy, aryloxy, phenoxy, benzyloxy, heteroaryloxy, arylalkyloxy, amino, alkylamino, acylamino, aminoalkyl, arylamino, sulfonylamino, sulfinylamino, sulfonyl, alkylsulfonyl, arylsulfonyl, aminosulfonyl, sulfinyl, alkylsulfinyl, arylsulfinyl, aminosulfinylaminoalkyl, —C(═O)OH, —C(═O)R^{a}, —C(═O)OR^{a}, C(═O)NR^{a}R^{b}, C(═NOH)R^{a}, C(═NR^{a})NR^{b}R^{c}, NR^{a}R^{b}, NR^{a}C(═O)R^{b}, NR^{a}C(═O)OR^{b}, NR^{a}C(═O)NR^{b}R^{c}, NR^{a}C(═NR^{b})NR′R^{d}, NR^{a}SO₂R^{b}, —SR^{a}, SO₂NR^{a}R^{b}, —OR^{a}, OC(═O)NR^{a}R^{b}, OC(═O)R^{a} and acyl, wherein R^{a}, R^{b}, R^{c} and R^{d} are each independently selected from the group consisting of H, C₁-C₁₂alkyl, C₁-C₁₂haloalkyl, C₂-C₁₂alkenyl, C₂-C₁₂alkynyl, C₂-C₁₀ heteroalkyl, C₃-C₁₂cycloalkyl, C₃-C₁₂cycloalkenyl, C₂-C₁₂heterocycloalkyl, C₂-C₁₂ heterocycloalkenyl, C₆-C₁₈aryl, C₁-C₁₈heteroaryl, and acyl, or any two or more of R^{a}, R^{b}, R^{c} and R^{d}, when taken together with the atoms to which they are attached form a heterocyclic ring system with 3 to 12 ring atoms.

In some embodiments each optional substituent is independently selected from the group consisting of: halogen, ═O, ═S, —CN, —NO₂, —CF₃, —OCF₃, alkyl, alkenyl, alkynyl, haloalkyl, haloalkenyl, haloalkynyl, heteroalkyl, cycloalkyl, cycloalkenyl, heterocycloalkyl, heterocycloalkenyl, aryl, heteroaryl, hydroxy, hydroxyalkyl, alkyloxy, alkyloxyalkyl, alkyloxyaryl, alkyloxyheteroaryl, alkenyloxy, alkynyloxy, cycloalkyloxy, cycloalkenyloxy, heterocycloalkyloxy, heterocycloalkenyloxy, aryloxy, heteroaryloxy, arylalkyl, heteroarylalkyl, arylalkyloxy, amino, alkylamino, acylamino, aminoalkyl, arylamino, sulfonyl, alkylsulfonyl, arylsulfonyl, aminosulfonyl, aminoalkyl, —COOH, —SH, and acyl.

Aryl azo compounds are usually stable, crystalline species. Azobenzene is the prototypical aromatic azo compound. It exists mainly as the trans isomer, but upon photolysis, converts to the cis isomer.

Aryl azo compounds typically have vivid colours, especially reds, oranges, and yellows. These compounds may be referred to as “azo dyes” and include, for example, Acid Orange 7 (see below), Disperse Orange 1, Sudan I, Sudan II, Sudan III, Sudan IV; methyl orange, methyl red, methyl yellow; Congo red; Sunset Yellow FCF; Orange G and Acid red, C.I. reactive blue 225, C.I. reactive yellow 125 and C.I. basic red 46 among others.

In some embodiments the azo dye may be Acid Orange 7 (AO7), also known as 4-(2-Hydroxy-1-naphthylazo) benzenesulfonic acid sodium salt, which has the following molecular structure:

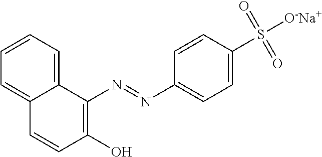

Most azo dyes contain only one azo group, but may contain two azo groups (disazo), three azo groups (trisazo) or more.

In addition, the terms “azo compound” or “azo dye” should be understood to include corresponding tautomers of azo compounds or azo dyes.

Aliphatic azo compounds (where R¹ and/or R² are alkyl groups) are less commonly encountered than the aryl azo compounds. One example is diethyldiazene, EtN═NEt. At elevated temperatures or upon irradiation, the carbon-nitrogen (C—N) bonds in certain alkyl azo compounds cleave with the loss of nitrogen gas to generate radicals. Owing to this process, some aliphatic azo compounds are utilized as radical initiators. Representative is Azobisisobutylonitrile (AIBN) which is widely used as an initiator in polymerization.

As set out above, the present invention contemplates contacting the sample with a photocatalyst under conditions suitable for degradation of the contaminant by the photocatalyst.

In some embodiments, the conditions suitable for degradation of the contaminant by the photocatalyst comprise visible light irradiation.

In some embodiments, the conditions suitable for degradation of the contaminant by the photocatalyst comprise solar radiation.

In some embodiments where the conditions suitable for degradation of the contaminant by the photocatalyst comprise visible light irradiation and/or solar radiation, the photocatalyst may be applied to the sample at a dosage range of 300-700 mg of photocatalyst per litre of sample, 400-600 mg of photocatalyst per litre of sample or 450-550 mg of photocatalyst per litre of sample.

In some embodiments, the conditions suitable for degradation of the contaminant by the photocatalyst comprise ultraviolet light irradiation.

In some embodiments where the conditions suitable for degradation of the contaminant by the photocatalyst comprise ultraviolet light irradiation, the photocatalyst may be applied to the sample at a dosage range of 25-175 mg of photocatalyst per litre of sample, 50-150 mg of photocatalyst per litre of sample or 75-125 mg of photocatalyst per litre of sample.

In some embodiments, the conditions suitable for degradation of the contaminant by the photocatalyst comprise a pH of between 4 and 8. In some embodiments, the conditions suitable for degradation of the contaminant by the photocatalyst comprise a pH of about 6.

In some embodiments, the conditions suitable for degradation of the contaminant by the photocatalyst comprise a temperature selected from the list consisting of: between 10° C. and 50° C., between 15° C. and 45° C., between 20° C. and 40° C. and between 25° C. and 35° C. In some embodiments, the conditions suitable for degradation of the contaminant by the photocatalyst comprise a temperature of about 30° C.

The degradation of the contaminant may include decolourisation and/or mineralisation of the contaminant.

The term “decolourisation” should be understood to mean a loss of absorbance at one or more wavelengths of light of the contaminant. Typically, decolourisation involves loss of absorbance at one or more visible wavelengths of light. Furthermore, decolourisation may be partial or complete.

The term “mineralisation” should be understood to mean the loss of one or more atoms from the molecules of the contaminant, resulting in a contaminant of reduced molecular weight. In some embodiments, mineralisation involves any decrease in the amount of organic carbon in a contaminant and/or the production of carbon dioxide as a product of photocatalysis.

In some embodiments, wherein the contaminant is an azo compound, degradation of the compound may also comprise cleavage of an N═N bond in the azo compound to yield products of lower molecular weight and/or nitrate anions.

The method of the second aspect of the invention may lead to substantial degradation of a contaminant under visible light irradiation and/or solar radiation. For example, in some embodiments, the contaminant may be at least 30%, at least 40%, at least 50%, at least 60%, at least 70%, or at least 80% degraded after contact with the photocatalyst under visible light irradiation and/or solar radiation.

The sample containing the contaminant contemplated for the third aspect of the invention may be any solid, liquid or gas which contains a contaminant and may be amenable to photocatalytic degradation of the contaminant. When the contaminant is an environmental contaminant (eg. a dye), the sample may be an environmental sample such as a water sample, a soil sample, a gaseous or atmospheric sample and the like. In some embodiments the sample may be an effluent sample from industry including liquid effluents such as wastewater or gaseous effluents. In some embodiments, the sample may be a water or wastewater sample.

In some embodiments, the photocatalyst may be recovered from a sample after treatment and reused. Methods for recovering the photocatalyst from the sample include, for example, sedimentation, filtration and/or centrifugation. Alternatively, the photocatalyst may be bound to a solid support to facilitate simple removal from the sample.

The photocatalyst may also be incorporated into other products or devices to facilitate photocatalytic degradation of contaminants that come into contact with the product or device. Such products or devices may include, for example, building materials such as bricks, mortars, external wall cladding, internal wall or ceiling linings such as plasterboards, tiles, roofing materials, paints and the like; air or water filters; linings or coatings for the surfaces of vessels; and the like.

The present invention is further described by the following non-limiting examples.

While the invention will now be described in connection with certain examples so that aspects thereof may be more fully understood and appreciated, it is not intended to limit the invention to these particular embodiments or examples. On the contrary, it is intended to cover all alternatives, modifications and equivalents as may be included within the scope of the invention as defined by the appended claims. Thus, the following examples will serve to illustrate the practice of this invention, it being understood that the particulars shown are by way of example and for purposes of illustrative discussion of preferred embodiments of the present invention only and are presented in the cause of providing what is believed to be the most useful and readily understood description of embodiments of the invention as well as of the principles and conceptual aspects of the invention.

### Example 1

### Preparation of Modified TiO₂ Photocatalysts

Iron (III) modified TiO₂ photocatalysts were prepared by a controlled hydrolysis process as described below.

Titanium butoxide [Ti(OBu)₄] was slowly added into ethanol with continuous stirring. The pH value was then adjusted to range between 1.8-2.1 with nitric acid. Next, deionized water was added to the mixture. The composition (molar ratio) was controlled at 25:1:3.5 for ethanol: Ti(OBu)₄: H₂O.

While stirring the mixture, various amounts of ferric nitrate [Fe(NO₃)₃] were added. Suitable amounts of ferric nitrate included 0.05 g˜0.2 g/20 ml of the ethanol/Ti(OBu)₄/H₂O mixture, with 0.15 g being particularly suitable. These ratios lead to a concentration of about 2 wt. % ferric ion in the final titanium dioxide matrix.

The solution was maintained at room temperature for a few days until a gel could be obtained. Then the gels were dried at 60-70° C. in a vacuum for 3 hours and then milled. The materials were finally calcined at −450° C. for 3 hours.

A photocatalyst produced according to the method described above is referred to hereafter as the “synthesised photocatalyst”.

### Example 2

### Photocatalytic Degradation Procedures

The photocatalytic activity of the synthesised photocatalyst was evaluated by the degradation of an azo dye, Acid orange 7 (AO7), artificially mixed textile wastewater (mixture of organic dyes: Drimarene Navy KBNN GRAN, Drimarene Yellow K-2R, and Maxilon Red GRL 200%), and real dyehouse effluent sampled from Melba Industries located in Geelong, Victoria.

The initial concentrations of organic dyes used were 25-50 mg I⁻¹ which was close to the characteristic dyes concentration range (10-50 mg I⁻¹) in wastewater from the textile industry. The photocatalytic experiments were conducted in a photoreactor housing a UV lamp (predominantly 365 nm). Visible irradiation (>420 nm) was achieved by circulating cold aqueous potassium dichromate solution between the UV lamp and the reaction mix.

In a typical run, dye solution was loaded in the vessel and slurried with an appropriate concentration of photocatalyst. Experiments were performed at ambient pH and temperature which were left uncontrolled during the reaction. Samples periodically drawn from the vessel were analyzed with respect to color and total organic carbon (TOC) change after catalyst particles removal. Photocatalytic degradation end products were analyzed through ion chromatography (IC).

### Example 3

### Photocatalytic Activity Under UV Light Irradiation

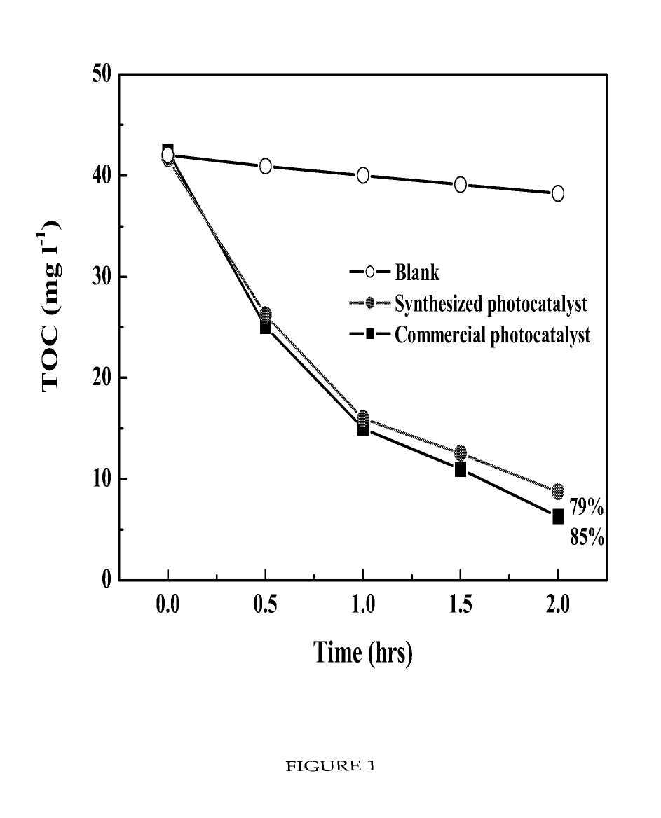

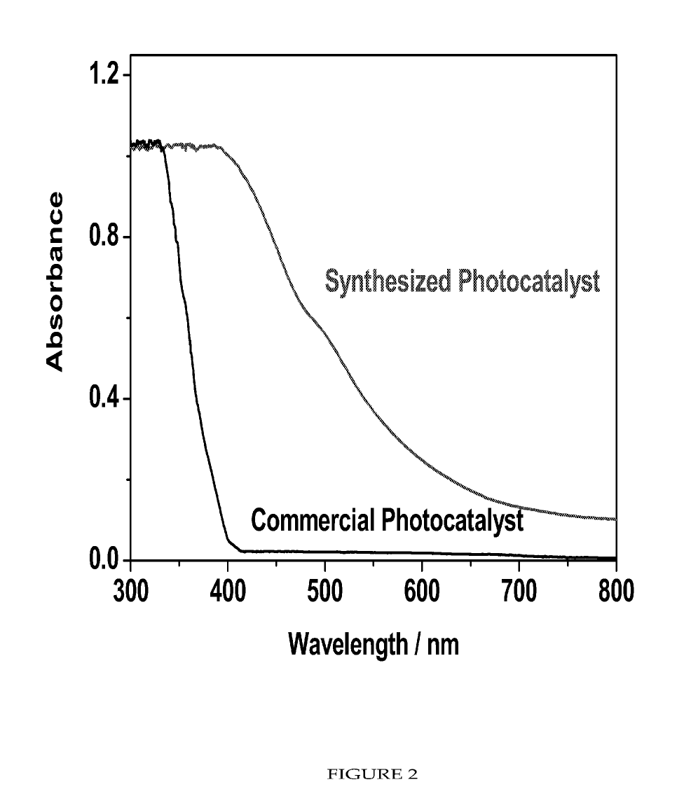

Through tracing the change of total organic carbon (TOC) of the treated dye solution with time, it can be seen that the synthesised photocatalyst exhibited highly efficient AO7 degradation (FIG. 1). After 2 hours AO7 was mineralized by 79%, which was comparatively as high as that achieved with the use of commercial TiO₂ (Degussa P25, 140AUD/500 g) (85% mineralized). UV light activation was required for commercial TiO₂ (Degussa P25) photocatalytic activity, and the P25 TiO₂ was relatively inactive under visible light irradiation (FIG. 2).

In contrast, the synthesized photocatalyst displayed a red-shifted absorption edge and enhanced absorptions in the range from 400 to 800 nm (FIG. 2). Increased light absorption in the visible region suggested that the synthesized photocatalyst may be photocatalytically active under visible light irradiation.

### Example 4

### Photocatalytic Activity Under Visible Light Irradiation

AO7 Degradation

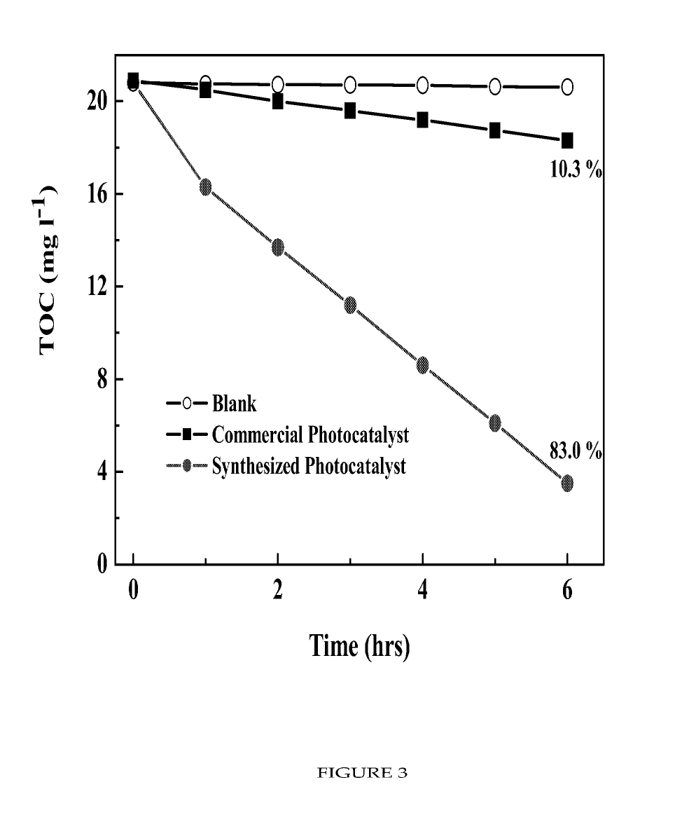

As shown in FIG. 3, the synthesized photocatalyst showed high efficiency for AO7 degradation with visible light as an irradiation source. In 6 hours 2.5 I of 25 mg I⁻¹ AO7 solution was mineralized by 83% which was far better than that obtained through the use of the commercial P25 TiO₂, wherein only 10.3% was mineralized.

Artificial Textile Wastewater Degradation

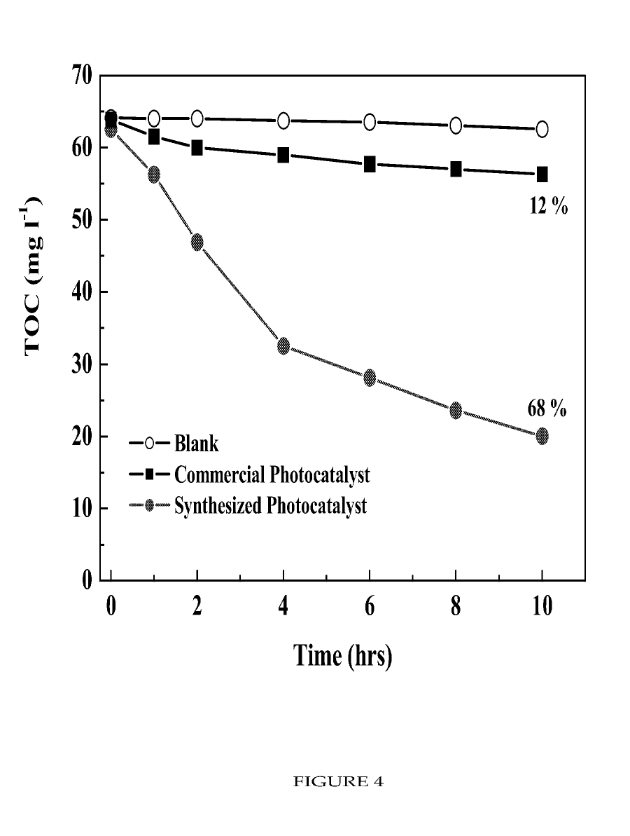

As shown in FIG. 4, with the use of the synthesized photocatalyst, artificial textile wastewater was greatly decolorized and mineralized by 68% in 10 hours. In contrast, the commercial TiO₂ Degussa P25 was only weakly active under visible light irradiation, with only a slight TOC decrease (12%).

Real Textile Wastewater Degradation

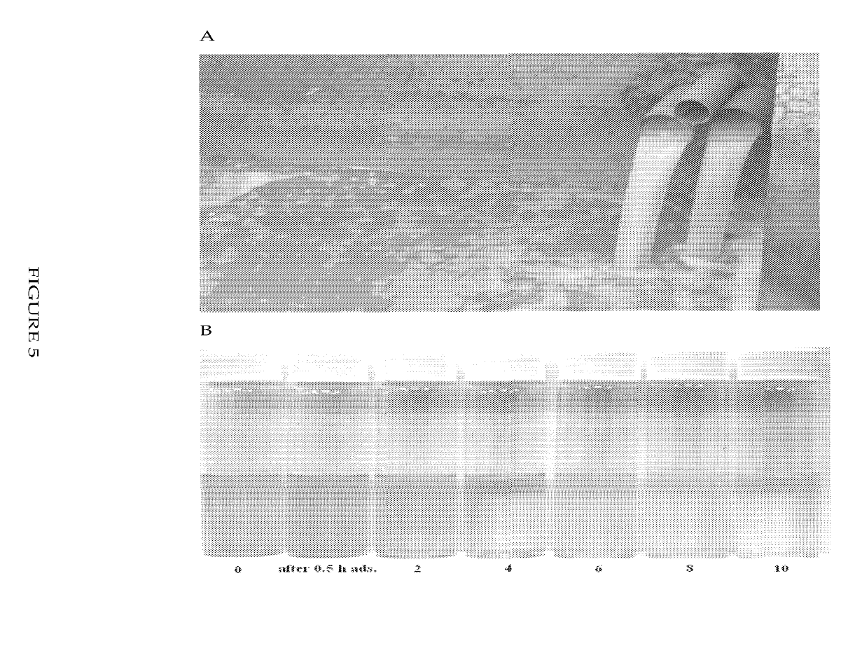

The synthesized photocatalyst worked well for real textile wastewater (shown in FIG. 5A) purification under visible light irradiation. As shown in FIG. 5B, in 10 hours the wastewater was substantially decolorized and odourless. This result was not achieved with the use of commercial P25 TiO₂.

### Example 5

### Analysis of Photodegradation End Products

The final treated solutions from the above-described photodegradation procedures for AO7 and artificial textile wastewater (ATW) under UV and visible light irradiation were investigated using ion chromatography (IC) analysis. As shown in Table 1, lower molecular weight organic acids were detected to be the main components and dominant source for the remaining TOC value in solutions after photodegradation. The nitrates detected evidenced the successful cleavage of azo bonds in the organic dyes. The degradation end products generally presented low or negligible environmental hazard.

TABLE 1
Photodegradation end products IC analysis (ppm)

| | Lactate | Acetic | Formic | Maleate | Oxalate | Citrate | Nitrate | Sulfate |
|---|---|---|---|---|---|---|---|---|
| AO7 under UV | — | 1.48 ± 0.03 | 2.59 ± 0.04 | 2.77 ± 0.02 | 6.33 ± 0.05 | 5.08 ± 0.05 | 16.0 ± 0.08 | 13.5 ± 0.05 |
| irradiation | | | | | | | | |
| AO7 under | — | 2.82 ± 0.02 | 4.35 ± 0.04 | 2.28 ± 0.02 | 4.75 ± 0.05 | 7.75 ± 0.06 | 7.50 ± 0.05 | 10.05 ± 0.08 |
| Vis irradiation | | | | | | | | |
| ATW under | 1.61 ± 0.01 | 2.57 ± 0.02 | 2.57 ± 0.02 | 1.66 ± 0.01 | 1.64 ± 0.01 | 9.47 ± 0.07 | 1.58 ± 0.01 | 12.83 ± 0.06 |
| UV irradiation | | | | | | | | |
| ATW under | 3.26 ± 0.02 | 3.76 ± 0.03 | 5.57 ± 0.05 | 2.33 ± 0.02 | 5.12 ± 0.04 | 8.42 ± 0.06 | 2.31 ± 0.01 | 18.10 ± 0.10 |
| Vis irradiation | | | | | | | | |

### Example 6

### Reusability of Synthesized Photocatalyst

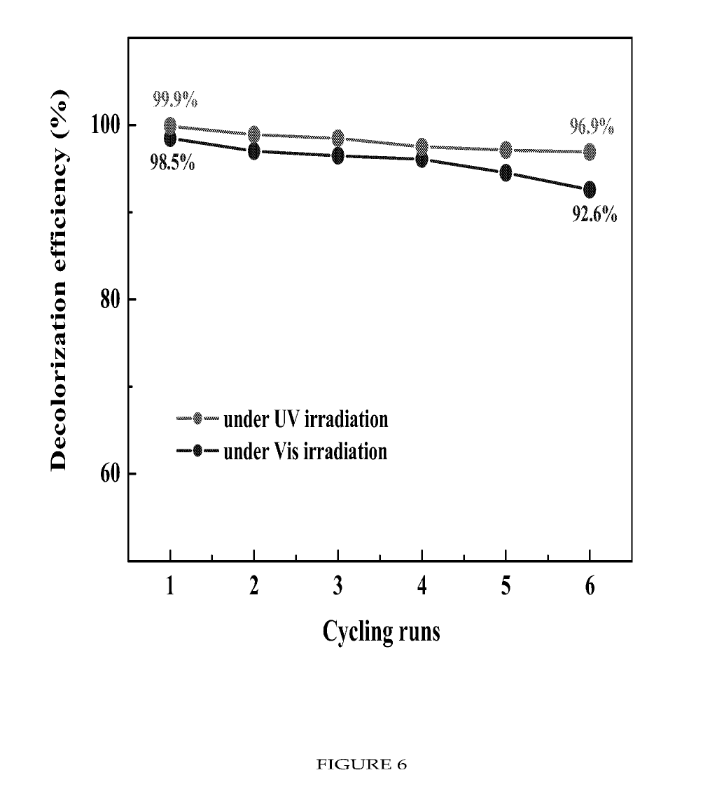

As shown in FIG. 6, the photocatalytic activity (for AO7 degradation) of the synthesized photocatalyst did not decrease significantly after six successive cycles under both UV (99.9% to 96.9%) and visible (98.5% to 92.6%) irradiation.

Photocatalyst recycle and reuse are of great practical significance from cost effectiveness point of view. Retrieval of the synthesized photocatalyst was easily performed through filtration. However it was difficult to recover used commercial TiO₂ P25 nanopowders which were heavily adsorbed on the reactor walls.

### Example 7

### Photocatalytic Activity Under Solar Radiation

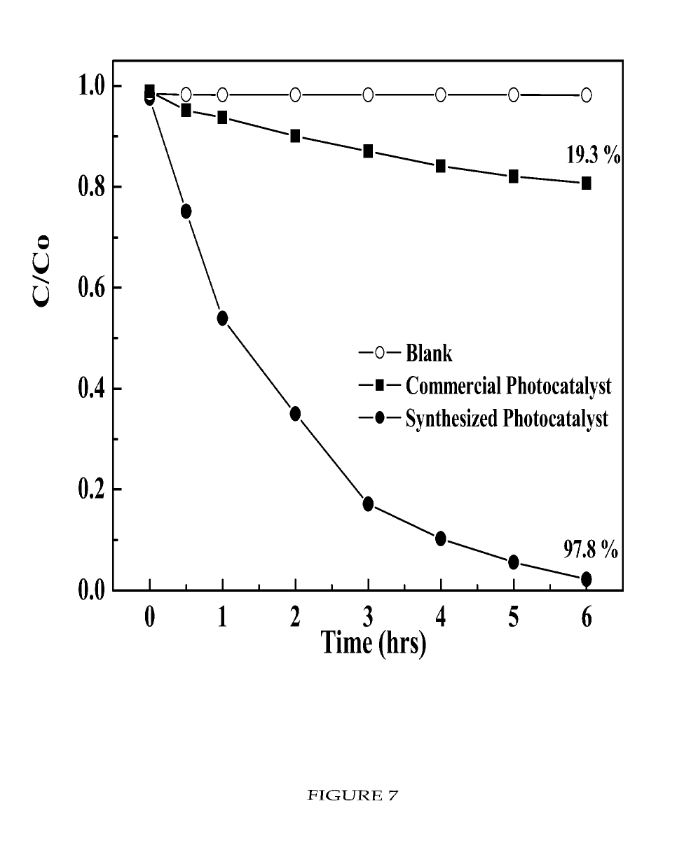

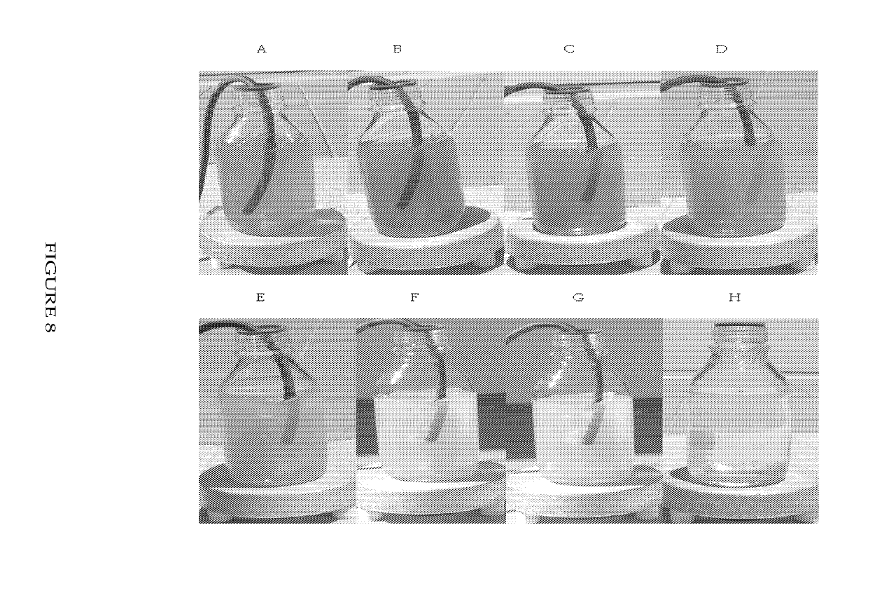

The photocatalytic activity of the synthesized photocatalyst under natural solar radiation was investigated during a summer season (January 2009) in Adelaide, South Australia. Sunny days were chosen with outdoor temperatures ranging from 27˜32° C. It was found that the synthesized photocatalyst exhibited high solar radiation photoactivity for Acid orange 7 (AO7) degradation (FIGS. 7 and 8). In 6 hours, almost complete degradation (97.8%) was achieved for 2.5 I of 50 mg I⁻¹ concentration of AO7 solutions. Under the same conditions, the commercial photocatalyst Degussa TiO₂ P25 showed much lower efficiency with only 19.3% degradation.

### Example 8

### Photocatalytic Activity Under Solar Light Irradiation

### Simulated and Real Textile Wastewater

The photocatalytic activity of the synthesized photocatalyst under natural solar light was investigated during a summer season in Adelaide, South Australia. Sunny days were chosen with outdoor temperature ranging from 27° C.˜32° C. Experiments were performed in 500 ml borosilicate glass bottle (Schott) with air sparging. Water was supplemented regularly to compensate for evaporation.

Simulated Textile Wastewater

The simulated textile wastewater contained mixed azo dyes (C.I. reactive blue 225, C.I. reactive yellow 125 and C.I. basic red 46 at 15 mg L⁻¹ each) and the following chemicals that represent those typically found in textile wastewater: Cr³⁺ (0.27 mg L⁻¹), Ca²⁺ (20 mg L⁻¹), Cl⁻ (400 mg L⁻¹), NO³⁻ (600 mg L⁻¹), SO₄²⁻ (100 mg L⁻¹), SO₃²⁻ (0.09 mg L⁻¹), HPO₄²⁻ (100 mg L⁻¹), and phenol (0.12 mg L⁻¹).

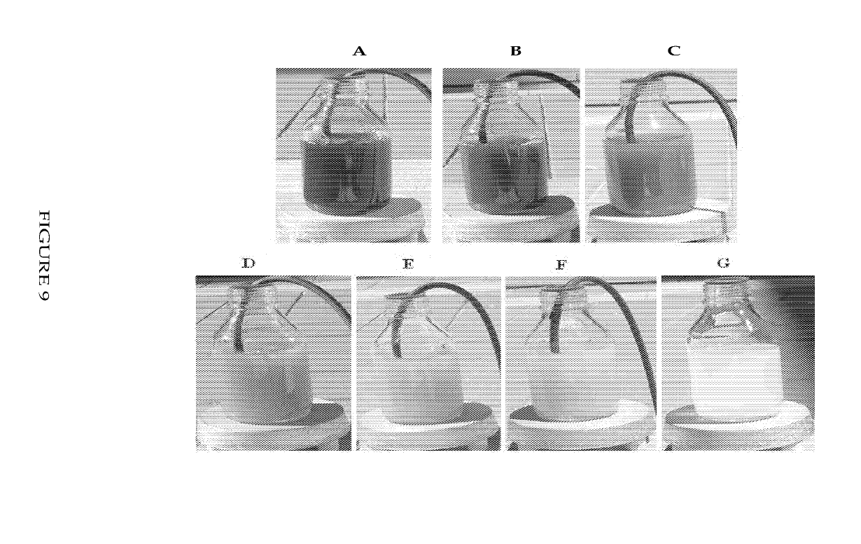

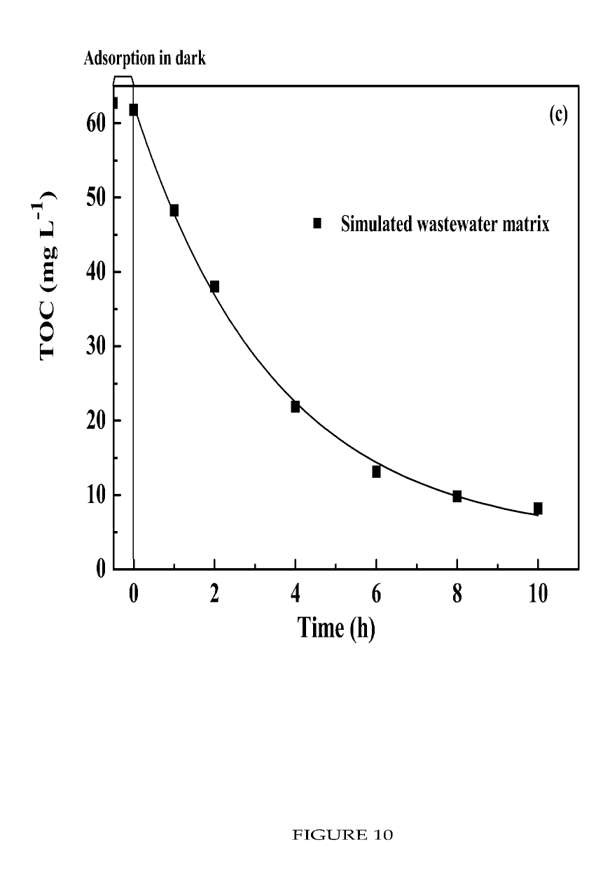

With the synthesised photocatalyst applied at 500 mg L⁻¹, after 10 h reaction time the mixed dyes were completely decolorized (see FIG. 9) and mineralized by 86.1% (see FIG. 10).

Real Textile Wastewater

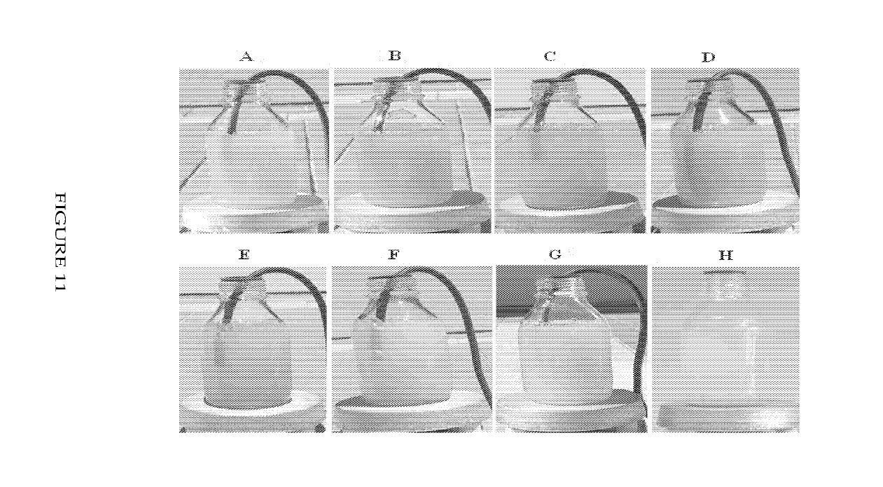

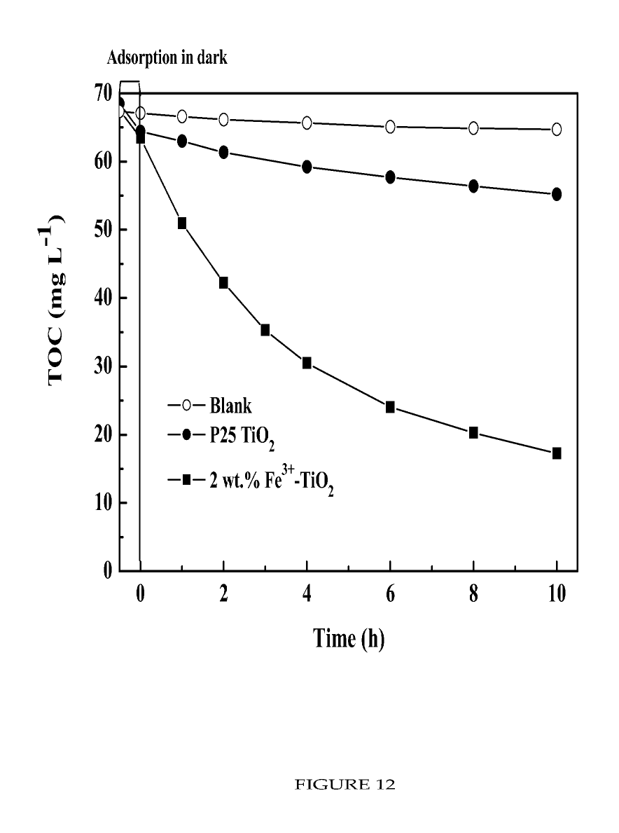

Textile wastewater was sampled from Melba industry, which is located in Geelong, Victoria, Australia. The synthesised photocatalyst achieved complete deodorization of 500 ml of textile wastewater in 4 h and nearly complete decolorization in 10 h (see FIG. 11). TOC analyses of the treated wastewater showed that the extent of mineralization after 10 h was 72.8% using the synthesised photocatalyst, which was 4 times better than that (14.2%) obtained with the use of P25 TiO₂ (see FIG. 12).

### Example 9

In comparison with the commercial TiO₂ (Degussa P25), the synthesised TiO₂ photocatalyst exhibited distinct advantages for organic dye degradation including, for example: high photocatalytic activity for both organic dye decolorization and mineralization; activity under both visible light irradiation and solar radiation; recyclability and reusability.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, items of manufacture, compositions of matter, means, methods and steps described in the specification. As one of ordinary skill in the art will readily appreciate from the disclosure of the present invention, processes, machines, items of manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, items of manufacture, compositions of matter, means, methods, or steps.

Each of the references, patents or publications cited herein is expressly incorporated by reference in its entirety.

1-30. (canceled)

31. A method for producing a photocatalyst, the method comprising the steps of:
(i) providing a reaction mixture containing:
a titanium alkoxide;
nitric acid;
water; and
a metal nitrate;
(ii) maintaining the reaction mixture for a time and under conditions to allow the formation of a gel; and
(iii) drying and/or calcining the gel.

32. The method of claim 31 wherein the titanium alkoxide is provided as a solution in an alcohol solvent to form a titanium alkoxide solution.

33. The method of claim 32 wherein the alcohol solvent is ethanol.

34. The method of claim 31 wherein the nitric acid is added to the titanium alkoxide solution to form a solution of titanium alkoxide and nitric acid.

35. The method of claim 34 wherein pH of the solution of titanium alkoxide and nitric acid is in the range of about 1.8 to about 2.1.

36. The method of claim 35 wherein the pH of the solution of titanium alkoxide and nitric acid is about 2.0.

37. The method of claim 32 wherein the reaction mixture comprises a molar ratio of alcohol:titanium alkoxide: H₂O of about 25:1:3.5.

38. The method of claim 31 wherein the titanium alkoxide is titanium butoxide.

39. The method of claim 31 wherein the metal nitrate is selected from the group consisting of: ferric nitrate, silver nitrate, platinum nitrate and copper nitrate.

40. The method of claim 31 wherein the drying comprises drying at a temperature within a range of 60° C. to 70° C. under vacuum for about 3 hours.

41. The method of claim 31 wherein the calcining comprises calcining at about 450° C. for about 3 hours.

42. A photocatalyst produced by the method comprising:
(i) providing a reaction mixture containing:
a titanium alkoxide;
nitric acid;
water; and
a metal nitrate;
(ii) maintaining the reaction mixture for a time and under conditions to allow the formation of a gel; and
(iii) drying and/or calcining the gel.

43. The photocatalyst of claim 42 wherein the photocatalyst has (1) increased photocatalytic activity under visible light irradiation relative to unmodified titanium dioxide under visible light irradiation; and/or (2) increased photocatalytic activity under solar radiation relative to unmodified titanium dioxide under solar radiation.

44. A method of degrading a contaminant in a sample containing the contaminant, the method comprising contacting the sample with the photocatalyst of claim 42 under conditions suitable for degradation of the contaminant by the photocatalyst.

45. The method of claim 44 wherein the contaminant is an organic dye or is an azo compound.

46. The method of claim 45 wherein the contaminant is selected from the group consisting of Acid orange 7, Drimarene Navy KBNN GRAN, Drimarene Yellow K-2R, Maxilon Red GRL, C.I. reactive blue 225, C.I. reactive yellow 125 and C.I. basic red 46.

47. The method of claim 44 wherein the conditions suitable for degradation of the contaminant by the photocatalyst comprise visible light irradiation, solar radiation, or ultraviolet light radiation.

48. The method of claim 44 wherein the photocatalyst is applied to the sample at a dosage in a range of 450-550 mg of photocatalyst per litre of sample or at a dosage in a range of 75-125 mg of photocatalyst per litre of sample.

49. The method of claim 44 wherein the conditions suitable for degradation of the contaminant by the photocatalyst comprise a pH of between 4 and 8.

50. The method of claim 44 wherein the conditions suitable for degradation of the contaminant by the photocatalyst comprise a temperature between 10° C. and 50° C.

51. The method of claim 44 wherein degradation of the contaminant comprises decolourisation of the contaminant.

52. The method of claim 44 wherein degradation of the contaminant comprises mineralisation of the contaminant.

53. The method of claim 45 wherein the containment is an azo compound and degradation of the azo compound comprises cleavage of an N═N bond in the azo compound.

54. The method of claim 44 wherein the sample is a water sample or wastewater sample.
